(19) United States
(12) Patent Application Publication
(10) Pub. No.: US 2017/0222439 A1
(43) Pub. Date: Aug. 3, 2017

(54) CONFIGURABLE INVERTER APPARATUS, PHOTOVOLTAIC SYSTEM COMPRISING SUCH AN INVERTER APPARATUS

(71) Applicant: ABB Schweiz AG, Baden (CH)

(72) Inventors: Sauro Macerini, Bucine (AR) (IT); Giovanni Manchia, Terranuova Bracciolini (AR) (IT); Luca Farese, Terranuova Bracciolini (AR) (IT)

(73) Assignee: ABB Schweiz AG, Baden (CH)

(21) Appl. No.: 15/309,772

(22) PCT Filed: May 8, 2014
(86) PCT No.: PCT/IB2014/061294

§ 371 Date: Nov. 8, 2016

(51) Int. Cl. H02J 3/38; H02M 3/04; H02M 7/5387

(52) U.S. Cl. CPC H02J 3/383; H02M 7/5387; H02M 3/04

(57) ABSTRACT

A photovoltaic inverter apparatus adapted to be connected at the input to a photovoltaic panel and at the output to a public electric grid and to a user, wherein said inverter apparatus comprises a DC input stage adapted to receive DC electricity generated by said photovoltaic panel; an alternating conversion stage coupled to said input stage, adapted to convert said DC electricity into alternating electricity and to supply it at the output, wherein said alternating conversion stage is configured to transform said alternating electric energy flow in a selective manner; connection means for selectively connecting said alternating conversion stage to the electric grid or to an isolated load in single-phase or two-wire mode, or in three-phase mode.

### FIELD OF THE INVENTION

The present invention field relates to inverter apparatuses adapted to convert DC electricity into AC electricity, and in particular intended for photovoltaic systems for generating electricity from solar energy.

### PRIOR ART

The ever increasing energy needs require new energy procurement forms. For this purpose, the most recent technological developments are focused on best exploiting renewable resources available in nature. For generating electricity from natural sources, photovoltaic systems, which allow to transform solar energy into electricity, have been developed for several years.

In general, a photovoltaic system 1 comprises at least one photovoltaic panel exposed to solar radiation to receive solar energy and generate direct current electricity from solar energy. An inverter apparatus is connected to the output of the solar panel for converting the direct current (generated by the solar panel) into alternating current. Local users and electric loads and/or the public electric grid are usually connected to the output of the inverter apparatus. Inverter apparatuses connected to the electric power grid are known as grid-connected systems, while devices corrected to local users and loads are known as standalone systems.

The electric features of the public grid are determined by the electric supply standards adopted in each country. Therefore, an inverter apparatus must be electrically compatible with such standards in order to transfer the generated electricity to the grid.

The electric features of the public grid are substantially constant over time; it is indeed very rare for supply standards to change. So, the parameters for transferring electricity to the grid that an inverter apparatus must respect once connected to the electric grid do not need later adaptations once they have been designed.

Similarly, local users and energy loads receive energy according to the aforesaid electric supply standards, and thus the same compatibility between the inverter apparatus output and the voltage delivered by the electric grid must be ensured also when the inverter apparatus supplies such users.

However, the users and electric loads to be supplied may have very different electric features. For example, some users may require a three-phase electric supply, such as for example industrial users, while other users may require single-phase electric supply of the simple type or with two separate phases, as in the case of domestic users. The known solutions described in part do not allow to obtain an inverter apparatus which ensures a sufficient installation flexibility such as to make it adapted to different types of users. As mentioned above, an inverter apparatus is generally adapted to satisfy a particular type of user according to which it is designed and made. Such a constraint is a problem of manufacturers and for users of inverter apparatus which require to make and use different product ranges according to the various destinations of use.

It is thus the general object of the present invention to obtain an inverter apparatus and a photovoltaic system comprising said inverter apparatus which allows to overcome the disadvantages of the prior art in a simple and cost-effective manner.

It is a first object of the present invention to provide an inverter apparatus which is adapted for any destination of use, operating both in grid-connected and the standalone mode.

It is a second object of the present invention to provide an inverter apparatus which may be simply switched between different operative modes, and in particular between grid-connected and standalone operative modes.

In general, an inverter apparatus according to the present invention is provided with first terminals adapted to be connected to a DC voltage and current source, e.g. a photovoltaic panel, and second terminals adapted to be connected to a public electric grid and to a user, and comprises:

a DC/DC type conversion stage at the input, adapted to receive by means of said first terminals a direct electric current generated by said photovoltaic panel;

a DC/AC type conversion stage at the output, associated with said DC/DC type conversion stage at the input, adapted to convert said direct electric current into alternating electric current and to supply said alternating electric current at the output by means of said second terminals;

means for selectively connecting said DC/DC type conversion stage to the electric grid or an isolated load in single-phase or two-wire mode, in which one wire comprises an alternating voltage and the other wire the reference voltage, single-phase or three-wire mode, in which two wires comprise two offset alternating voltages and the other wire the reference voltage, or in three-phase mode.

The inverter apparatus according to the present invention is adapted to operate with any input DC voltage source, in particular but not exclusively with DC voltages generated by photovoltaic systems.

The present invention further relates to a photovoltaic system provided with an inverter apparatus of the above-described type.

The configurable inverter apparatus object of the present invention therefore allows to conciliate the different needs of systems of the grid-connected type and of the standalone type by virtue of an innovative structure which comprises the features of both the aforesaid systems and appropriate control means adapted to manage the selected operative mode according to the conditions of the load to supply.

Further features and advantages of the present invention will be apparent from the following description of a non-limitative embodiment with reference to the figures in the accompanying drawings, which are diagrammatic and show functional blocks adapted to be made according to different circuit solutions. In detail:

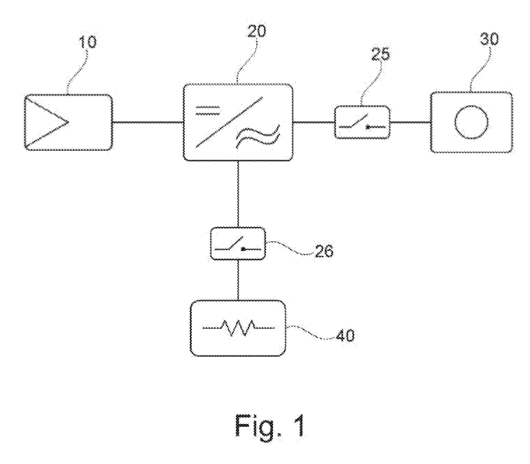

FIG. 1 shows a block diagram of a photovoltaic system for which the apparatus according to the present invention is intended;

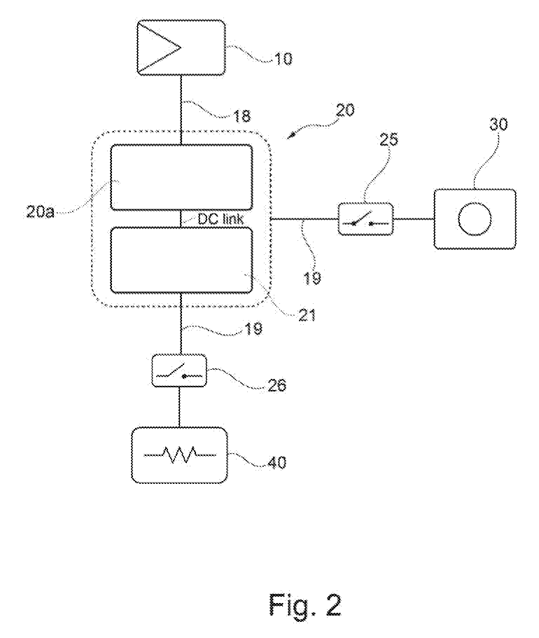

FIG. 2 shows a block diagram of a photovoltaic system equipped with the apparatus according to the present invention;

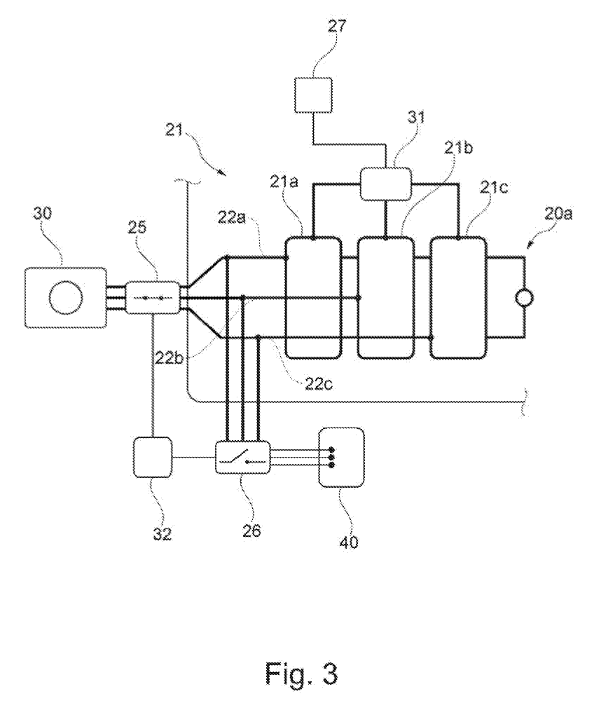

FIG. 3 shows the apparatus according to the present invention configured in a first operative mode;

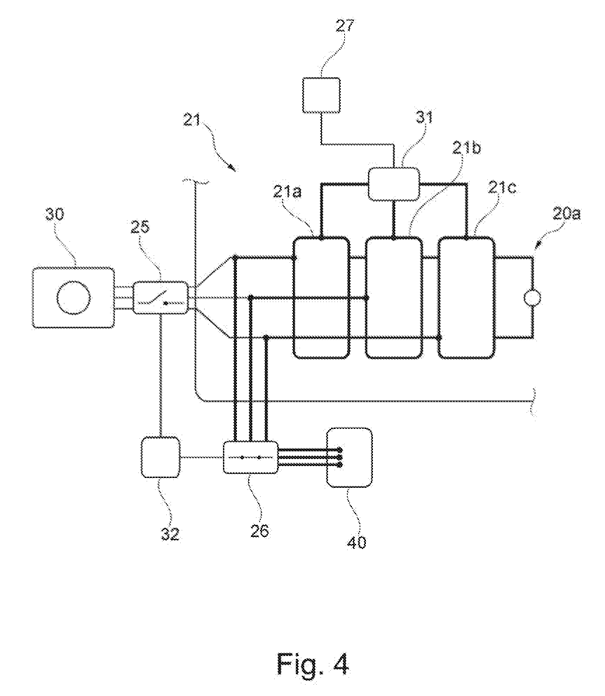

FIG. 4 shows the apparatus according to the present invention configured in a second operative mode;

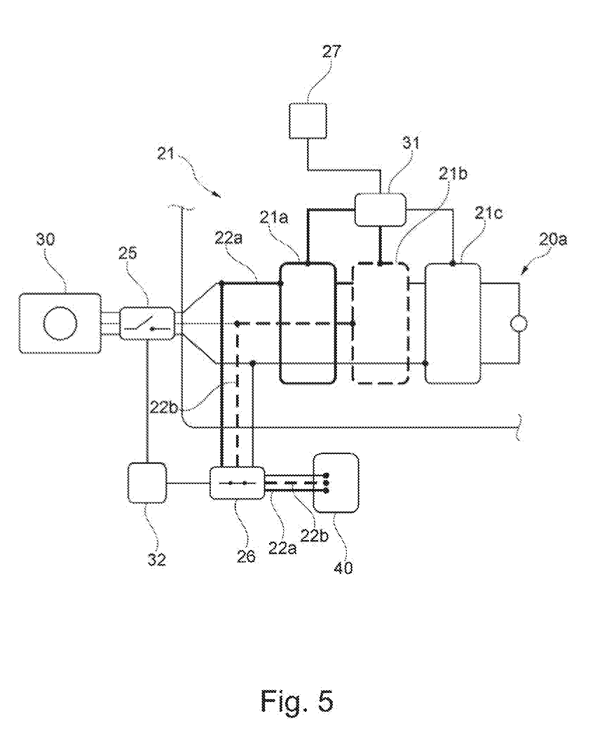

FIG. 5 shows the apparatus according to the present invention configured in a third operative mode;

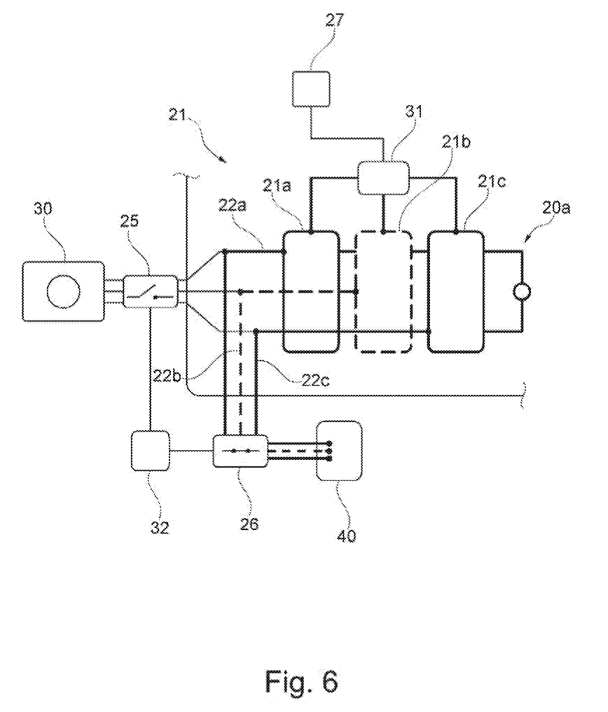

FIG. 6 shows the apparatus according to the present invention configured in a fourth operative mode.

### DETAILED DESCRIPTION OF THE INVENTION

The present description and accompanying drawings are provided by way of non-imitative example of the present invention only, which may be implemented according to other, different embodiments, always remaining within the scope of the appended claims.

FIG. 1 shows a photovoltaic system connected to a user 40 and a public electric grid 30. The photovoltaic system comprises a photovoltaic panel 10 adapted to be exposed to solar radiation to receive solar energy and generate DC electricity, from solar energy. Such a panel 10 is provided with an electric output by means of which it is connected to the inverter apparatus 20 according to the present invention.

Such an inverter apparatus 20 is, in turn, provided with an electric input which can be connected to the electric output of the panel 10. The inverter apparatus 20 is adapted to convert the direct electric current received from the panel 10 into alternating electric current. Such an alternating electric current is made available by means of an electric output with which the inverter apparatus 20 is provided. The inverter apparatus 20 may supply the generated electric current both to the electric grid 30 and to the user 40, according to the chosen operative mode. For this purpose, electric interfaces 25 and 26 are provided arranged between the inverter apparatus 20 and the electric grid 30, and between the inverter apparatus 20 and the user 40, respectively.

FIG. 2 shows a photovoltaic system equipped with an apparatus comprising an inverter apparatus 20 according to the present invention.

Such an inverter apparatus 20 is provided with first terminals 18 adapted to be connected to a photovoltaic panel and second terminals 19 adapted to be connected to a public electric grid and/or to a user. The inverter apparatus 20 further comprises:

A DC/DC conversion module 20 at the input, adapted to receive a DC electric voltage and current generated by the photovoltaic panel 10 by means of the first terminals 18, and to supply at the output a current and a regulated DC voltage, named bulk voltage or DC link. Said DC/DC conversion module 20a preferably comprises a converter of the so-called booster type;

a DC/AC conversion module 21 at the output, operatively associated with the DC/DC conversion module 20a and adapted to convert the direct electric current received from the DC/DC conversion module 20a and said DC bulk voltage into an alternating electric voltage and current and to supply said alternating current and said alternating voltage at the output by means of the second terminals 19. Said DC/AC conversion module 21 preferably comprises a DC/AC inverter;

connection means for selectively connecting said DC/AC conversion module 21 either to the electric grid or to a load in single-phase or two-wire mode, or in three-phase mode, said connection means comprising, for example, the aforesaid electric interfaces 25 and 26, arranged between the inverter apparatus 20 and the electric grid 30, and between the inverter apparatus 20 and the user 40, respectively;

control means of said DC/DC conversion module 20a and control means of said DC/AC conversion module 21, adapted to adjust the operation of said modules according to the operating modes of said inverter apparatus 20.

The DC/AC conversion module 21 is operatively coupled to said DC/DC conversion module 20a to receive direct electric current therefrom and convert it into alternating electric current. According to an embodiment, such a coupling is obtained by means of an electric connection circuit between the two DC/DC modules 20a and DC/AC 21. The second terminals 19 shown in the figure are two connection appendixes to the public electric grid 30 and to the user 40, obtained on the electric output which connects the DC/AC module 21 to the electric grid 30 and the user 40.

The DC/AC conversion module 21 is preferably connected to the electric grid 30 by means of a first electric interface 25, and to the user 40 by means of a second electric interface 26. According to an embodiment of the present invention, both the first electric interface 25 and the second electric interface 26 comprise at least one relay which either cuts off or enables the electric connection by switching from an open to a closed condition.

In order to conciliate the different control needs of the systems of the grid-connected and of the standalone types, in a preferred embodiment of the present invention said control means of said conversion means comprise the features required by both the control loops of the grid-connected type systems and the control loops of the standalone type systems. In particular, said control means of said conversion stage 21 comprise a first regulator of said DC bulk voltage (or DC link) and an output AC voltage regulator, while said control means of said input stage 20a comprise an input regulator of the DC voltage, for example, coming from the photovoltaic panel or panels used upstream, and a second DC bulk voltage regulator (or DC link).

In case of operation of the apparatus according to the present invention in grid-connected operative mode, said first DC bulk voltage regulator, comprised in said conversion stage 21, adjusts the input voltage value of said conversion stage 21 according to the available power to a level suited to the value peak of the grid voltage, which, in this operative mode is set and fixed. In this operative mode, indeed, the minimum value of the bulk voltage must never be lower than the nominal peak value of the grid voltage.

Furthermore, in the case of operation of the apparatus according to the present invention in grid-connected operative mode, said input DC voltage regulator, comprised in said input stage 20s, adjusts the voltage at the input of the apparatus 20 according to the present invention, for example, to maximize the power transfer from the photovoltaic panel by implementing an appropriate MPPT (Maximum Power Point Tracking) algorithm according to techniques known in the art.

In the case of operation of the apparatus according to the present invention in standalone operative mode, said regulator of the AC voltage output by said conversion stage 21 adjusts said output AC voltage according to the settings and the desired level. In this operating mode, the DC bulk voltage (or DC link) is adjusted by means of said second DC voltage bulk regulator.

The presence of said first DC bulk voltage regulator in said conversion stage 21 allows to manage operating situations in which the power available at the input to the apparatus 20 cannot satisfy the load demand.

More in detail, when the available power at the input of the inverter apparatus 20 is higher than the power demanded by the load, the DC bulk voltage tends to increase as a consequence of the fact that the inverter apparatus 20 cannot transfer all the available input power to the load. In this operating condition, said second DC bulk voltage regulator intervenes by adjusting said DC bulk voltage according to a reference value Vbulk_ref booster, which is higher than the reference value of said first DC bulk voltage regular Vbulk_ref inverter.

In brief, in the above-described condition, said second DC bulk voltage regulator prevails with respect to said first DC bulk voltage regulator.

When, instead, the power available at the input of the inverter apparatus 20 is lower than the power demanded by the load, the DC bulk voltage tends to decrease to reach the reference value of said first DC bulk voltage regulator Vbulk_ref inverter. Thus, at this point said first DC bulk voltage regulator will take charge of adjusting such a voltage resulting in a lower voltage which is lower than, but in all cases compatible with, the required operative ranges, while said input DC voltage regulator comprised in said input stage 20a keeps adjusting the voltage at the input of the inverter apparatus 20 according to the present invention.

The FIGS. 3, 4, 5 and 6 illustrate an embodiment of said DC/AC conversion module 21 referred to four different operative modes of the apparatus according to the present invention.

Preferably, said DC/AC conversion module 21 comprises a three-phase voltage generator comprising, in turn, three conversion cells 21a, 21b, 21c, for example, each comprising a half-bridge or a whole bridge made with semiconductor controlled switches of the MOSFET or IGBT type.

Such three cells 21a, 21b, 21c supply a corresponding alternating voltage with a corresponding phase to the respective three outputs 22a, 22b and 22c. Said three-phase voltage generator is operatively coupled to the DC/DC conversion module 20s so as to receive at the input direct electric current, convert such a direct electric current into alternating electric current and make it available by means of one or more of its terminals 21a, 21b and 21c.

According to an embodiment, the inverter apparatus 20 according to the present invention comprises a control unit 31 connected to said DC/AC conversion module 21. Such a control unit 31 is adapted to control said DC/AC conversion module 21 and said connection means for selectively connecting said DC/AC conversion module 21 to the electric grid 30 or to an isolated load 40 and selecting one or more operative modes. Such an aspect will be more apparent with reference to FIGS. 4, 5 and 6 which illustrate three different operative modes set by the unit 31.

According to an embodiment, governing means 32 are provided for selectively controlling the relay groups 25 and 26. Preferably, the governing means 32 are associated with the control unit 31 by means of a connection (not shown in the accompanying figures), to control thereby the relay groups 25 and 26 in a synchronized manner according to the selected operative mode.

FIG. 3 shows an embodiment of an inverter apparatus 20 according to the present invention, in which the control unit 31 selects a first operative mode.

According to this first operative mode, the control unit 31 operates said DC/AC to conversion module 21 so to supply three-phase alternating electric voltage and current to the electric grid 30. In particular, the three transformation cells 21a, 21b, 21c are activated to supply three corresponding voltages, each with a phase thereof, by means of three connections 22a 22b and 22c. The apparatus according to the present invention works as alternating current generator.

FIG. 4 shows said DC/AC conversion module 21 set to a second operative mode of the control unit 31.

In said second operative mode, three-phase alternating electric voltage and current is supplied to the user 40 Also in this case, the three transformation cells 21a, 21b, 21c are activated to supply three corresponding voltages, each with a phase thereof, by means of three terminals 22a 22b and 22c. In this case, the apparatus according to the present invention works as alternating voltage generator with a power rating equivalent to the nominal power related to said first operative mode with respect to which the operative hardware of said DC/AC conversion module 21 remains unchanged and the output of said DC/AC conversion module 21 is simply isolated from the electric grid 30 and connected to said user 40.

FIG. 5 shows said DC/AC conversion module 21 set to a third operative mode of the control unit 31.

In said third operative mode, indicated as single-phase or two-wire mode above, single-phase alternating electric voltage and current is supplied to the user 40 by completely deactivating one of the output phases (for example, by deactivating the PWM control of the corresponding cell 21c) and in fact creating an a inverter apparatus 20 of the single-phase type, thus making a standalone output of the 1PH/2 W (single-phase or two-wire) type available with a power rating equal to one third of the nominal power related to said first operative mode. In this third operative mode, for example, said control unit 31 keeps the transformation cell 21a active by setting a given output voltage with a given phase, and further activates the cell 21b (shown in FIG. 5 by a dashed line) in order to refer the voltage set to ground, for safety reasons. The cell 21c is finally deactivated. Thereby, a single-phase voltage and respective ground reference is supplied to the user 40, by means of the terminals 22a and 22b.

FIG. 6 shows said DC/AC conversion module 21 set to a fourth operative mode of the control unit 31.

In said fourth operative mode, a double voltage and a single-phase alternating electric current are supplied to the user 40.

In this fourth operative mode, indicated above as single-phase or two-wire mode, the control unit 31, for example, activates the second cell 21b (shown with the dashed line) to generate a mean reference voltage value (for example, equal to half the value supplied by the DC/DC conversion module 20). The first cell 21a and the third cell 21c are generated with respect to the mean reference voltage value of the second cell 21b, thus obtaining two voltages with inverted respective phases. For example, the phase of the voltage at the terminal 22a is offset by 180° with respect to the terminal 22c.

In greater detail, for example, the second cell 21b can be exploited to create the neutral point for the other two phases generated by said first cell 21a and by said third cell 21c. Indicating with Vout₂ the voltage output by said second cell 21b, and setting for this phase an operating duty cycle σ2 constant and equal to 0.5 it results:

Vout₂=σ2×Vbulk=Vbulk/2

where Vbulk is the value supplied by the DC/DC conversion module 20a.

Indicating with Vout_ref the required voltage on the standalone single-phase or two-wire outputs, the modulation indexes at the output of the first cell 21a (σ1) and at the output of said third cell 21c (σ3) can be defined, respectively (minus the contribution from the control loops regulators) in the following manner:

σ1=Vout_ref/(Vbulk/2),

σ3=−Vout_ref/(Vbulk/2).

Thereby, two single-phase outputs are thus obtained with respect to the output voltage of the second cell 21b, which will represent the neutral reference and as such will be referred to ground.

When a higher regulation accuracy is required, a dynamic type control may be used by using feedback and modulating the operating duty cycle value.

According to an embodiment, the apparatus according to the present invention comprises a selection unit 27 for selecting the desired operative mode.

Said selection unit 27 may be advantageously accessible from the control and from the user interface of the apparatus according to the present invention, or may be remote and external to said apparatus and to said control unit 31 by means of a wired or wireless connection.

Furthermore, said selection unit 27 is advantageously configured for activating the three-phase alternating voltage generator, or the single-phase alternating voltage generator or the two independent single-phase alternating voltage generator according to the alternating electric voltage and current to be supplied to said electric grid 30 and to said user 40. In practice, in this embodiment, a user may select the operative mode to be activated according to the electric voltage and current to be supplied.

The present invention further relates to a photovoltaic system of the type connected to a public electric grid 30 and to a user 40 comprising:

at least one photovoltaic panel 10 comprising an electrical output adapted to be exposed to solar radiation to receive solar energy, and adapted to generate direct electric current and voltage from said solar energy;

an inverter apparatus 20 comprising an electric inverter input connected to the electric output of said photovoltaic panel 10, and an electric inverter output, such an inverter apparatus 20 being adapted to convert said DC electric voltage and current into alternating electric current and voltage and make it available by means said electric inverter output, for use by a public electric grid 30 and/or a user 40 connected to said electric inverter output, in which the inverter apparatus is of the above-described type.

1. An inverter apparatus comprising first terminals adapted to be connected to a DC electricity source and second terminals adapted to he electrically connected either to a public electric grid or to a user; a DC/DC conversion module adapted to receive at the input, by means of the first terminals, a DC electric voltage and current and to output a direct current and a regulated DC voltage; a DC/AC conversion module operatively associated with said DC/DC conversion module and adapted to convert said direct current and said regulated DC voltage into an alternating current and voltage and to supply said alternating current and voltage at the output by means of said second terminals; connection means for selectively connecting said DC/AC conversion module either to the electric grid or to a load in at least one operative mode selectable from a plurality of operative modes; a control unit adapted to control said DC/AC conversion module and said connection means for selectively connecting said DC/AC conversion module to the electrical grid or to a load and selecting at least, one of said operative modes; control means of said DC/DC conversion module and control means of said DC/AC conversion module, adapted to adjust the operation of said DC/DC conversion module and of said DC/AC conversion module according to the selected operative mode.

2. An inverter apparatus according to claim 1 which further comprises a selection unit adapted to select said operative mode.

3. An inverter apparatus according to claim 2 wherein said selection unit is provided with a user interface.

4. An inverter apparatus according to claim 1, wherein said plurality of operative modes comprises a first operative mode adapted to generate, at the output of said inverter apparatus, a single-phase alternating voltage referred to a reference voltage, a second operative mode adapted to generate, at the output of said inverter apparatus, a pair of single-phase alternating voltages referred to a reference voltage, a third operative mode adapted to generate, at the output of said inverter apparatus, a three-phase alternating voltage.

5. An inverter apparatus according to claim 1, wherein said control means of said DC/AC conversion module comprise a first regulator of said regulated DC voltage and a regulator of the AC voltage output by said conversion stage, and wherein said control means of said input stage comprise a DC voltage regulator at the input of said input stage and a second regulator of said regulated DC voltage.

6. An inverter apparatus according to claim 1, wherein said connection means comprise a first electric interface arranged between said DC/AC conversion module and the electric grid, and a second electric interface arranged between said DC/AC conversion module RV) and said load, said electric interfaces comprising at least one relay associated with appropriate governing means associated, in turn, with said control unit.

7. An inverter apparatus according to claim 1, wherein said DC/DC conversion module comprises a booster type converter.

8. An inverter apparatus according to claim 5, wherein said DC voltage regulator at the input of said input stage is adapted to maximize the power transfer from said photovoltaic panel by implementing an appropriate MPPT algorithm.

9. An inverter apparatus according to claim 1, wherein said DC/AC conversion module comprises a three-phase voltage generator comprising, in turn, three independent conversion cells, each comprising a half-bridge or whole bridge made with semiconductor controlled switches of the MOSFET or IGBY type.

10. An inverter apparatus according to claim 9, wherein said transformation cells can be configured by said control unit so as to supply an alternating three-phase voltage to said electrical grid.

11. An inverter apparatus according to claim 9, wherein said transformation cells can be configured by said control unit so as to supply an alternating three-phase voltage to said load.

12. An inverter apparatus according to claim 9, wherein said transformation cells can be configured by said control unit so that two of said three transformation cells are adapted to supply a single-phase alternating voltage of the 1PH/2 W type to said load.

13. An inverter apparatus according to claim 9, wherein said transformation cells can be configured by said control unit so that a first cell of said three transformation cells is adapted to supply a reference voltage and the other two cells of said three transformation cells are adapted to supply two alternating voltages referred to said reference voltage and having mutually inverted phases.

14. An inverter apparatus according to claim 1, wherein said direct electric current source comprises at least one photovoltaic panel.

15. A photovoltaic apparatus for generating and supplying single-phase or three-phase alternating electricity to a public electric grid (30) or a load (40) comprising: at least one photovoltaic panel comprising an electric output, adapted to be exposed to solar radiation to receive solar energy, and adapted to generate direct electric current and voltage from said solar energy; an inverter apparatus comprising an electric input connected to the electric output of said photovoltaic panel and an electric output, such an inverter apparatus being adapted to convert said DC electric voltage and current into single-phase or three-phase alternating electric current and voltage and to make it available, by means of said electric output, for use either by a public electric grid or a load connected to said electric output, wherein said inverter apparatus is of the type according to claim 1.

16. An inverter apparatus according to claim 2, wherein said plurality of operative modes comprises a first operative mode adapted to generate, at the output of said inverter apparatus, a single-phase alternating voltage referred to a reference voltage, a second operative mode adapted to generate, at the output of said inverter apparatus, a pair of single-phase alternating voltages referred to a reference voltage, a third operative mode adapted to generate, at the output of said inverter apparatus, a three-phase alternating voltage.

17. An inverter apparatus according to claim 2, wherein said control means of said DC/AC conversion module comprise a first regulator of said regulated DC voltage and a regulator of the AC voltage output by said conversion stage, and wherein said control means of said input stage comprise a DC voltage regulator at the input of said input stage and a second regulator of said regulated DC voltage.

18. An inverter apparatus according to claim 3, wherein said control means of said DC/AC conversion module comprise a first regulator of said regulated DC voltage and a regulator of the AC voltage output by said conversion stage, and wherein said control means of said input stage comprise a DC voltage regulator at the input of said input stage and a second regulator of said regulated DC voltage.

19. An inverter apparatus according to claim 2, wherein said connection means comprise a first electric interface arranged between said DC/AC conversion module and the electric grid, and a second electric interface arranged, between said DChAC conversion module arid said load, said electric interfaces comprising at least one relay associated with appropriate governing means associated, in turn, with said control unit.

20. An inverter apparatus according to claim 3, wherein said connection means comprise a first electric interface arranged between said DC/AC conversion module and the electric grid, and a second electric interface arranged between said DC/AC conversion module and said load, said electric interfaces comprising at least one relay associated with appropriate governing means associated, in turn, with said control unit.
